(19) United States
(12) Patent Application Publication
(10) Pub. No.: US 2016/0269453 A1
(43) Pub. Date: Sep. 15, 2016

(54) MULTI-PARTY TERM-BASED SOLUTION SYSTEM

(71) Applicant: Seth Redniss, New York, NY (US)

(72) Inventor: Seth Redniss, Brooklyn, NY (US)

(21) Appl. No.: 15/012,914

(22) Filed: Feb. 2, 2016

Related U.S. Application Data
(60) Provisional application No. 62/177,399, filed on Mar. 13, 2015.

(51) Int. Cl. H04L 29/06; H04L 12/18

(52) U.S. Cl. CPC H04L 65/403; H04L 65/60; H04L 12/1818

(57) ABSTRACT

An automated solution system for enabling a user to prepare content for one or more collaborations and communicate, discuss, negotiate, contract, or otherwise collaborate with one or more parties on any such collaborations.

### CROSS REFERENCE TO RELATED APPLICATIONS

The present application claims the benefit of the filing date of U.S. Provisional Patent Application Ser. No. 62/177,399 filed Mar. 13, 2015, and entitled “Multi Party Collaborative Solution System”.

### BACKGROUND OF THE INVENTION

### Description of the Related Art

The present invention relates to automated systems enabling parties to communicate, discuss or negotiate an identified set of terms and/or concepts of a potential agreement, collaboration or professional relationship and to incorporate the results of the exchange in contracts, agreements and/or other documents.

For any business, start-up, entrepreneur or individual, the process of establishing clear professional relationships that are accurately memorialized in writing needs can be time-consuming, confusing and expensive. Whether using attorneys or pre-made form agreements, both parties to a proposed agreement may be at a disadvantage in terms of understanding the relevance and/or importance of the provisions in a contract or agreement. This is also true in other areas such as sharing ideas and understandings, political debate, developing messages, etc. In the contracting context, the principle of “formation” is not directly addressed through the use of attorneys or pre-made forms, and is often ignored entirely.

Thus, there is a need in the art is for a system and a process that is based on the principle of “formation,” or mutual assent to material terms, and enables all parties to any collaboration, especially a legally binding business relationship, to identify and understand each key term or concept that is relevant to the collaboration or transaction and prepare agreements, contracts, understandings, positions, messages, or documents and enable the parties to communicate, discuss, negotiate and complete such collaborations and to do so fairly, inexpensively, collaboratively, quickly and in an informed manner, requiring the parties to focus on the essential terms of their prospective relationship at the outset of the process.

### SUMMARY OF THE INVENTION

An automated term or concept based solution system for enabling a user to identify, understand and create the essential terms or concepts for one or more potential transactions or collaborations and communicate, discuss, negotiate, contract or otherwise collaborate with one or more parties on the content for any such collaboration, the solution system comprising: an enabling system to allow use the solution system; one or more libraries with information and documents for preparing the content for a collaboration; one or more databases for tracking and recordkeeping for one or more collaborations; a content management system for controlling interactions between the enabling system, libraries and user databases.

The solution system as described above further comprising: a control panel for display of the content and status of collaborations and for use of the solution system.

The solution system as described above wherein the user may initiate and prepare content for one or more collaborations.

The solution system as described above wherein collaborating among the user and the parties for a collaboration may be enabled and collaboration activity made known to the user and the parties.

The solution system as described above wherein communications, discussion, negotiations and/or contracts with/on the collaboration may occur between the users or parties.

The solution system as described above wherein changes to the content of a collaboration are tracked and differentiated.

The solution system as described above wherein collaborations that are completed or agreed upon are so designated.

The solution system as described above wherein a final version of the content for a collaboration is generated upon completion.

The solution system as described above wherein authorized signatures may be generated for a completed collaboration.

The solution system as described above wherein the user and the parties to a collaboration are sent notifications of collaboration activity.

The solution system as described above wherein explanatory information for the content of a collaboration are displayed to the user and the parties.

The solution system as described above wherein portions of the content for a collaboration may be made non-changeable.

The solution system as described above further comprising a collaboration content subsystem wherein, from responses by the user to one or more instructions or questions from the collaboration content subsystem, the solution system identifies an appropriate document for the user to use for preparing content for a collaboration.

The solution system as described above wherein different languages may be used.

An automated system for assisting a user to prepare content for a matter, the system comprising: one or more libraries with documents that can be selected for use by a user; an enabling system to allow the user to access such documents; and wherein, one or more of the documents have notes with explanatory information to assist the user with preparing the content of the matter.

The automated system as described above wherein the notes are displayable to one or more parties in collaboration with the user.

The system as described above further comprising a content subsystem wherein, from responses by the user to one or more instructions or questions from the content subsystem, the system identifies an appropriate document for the user to use for preparing the content of a matter.

In an automated solution system for enabling a user to prepare content for one or more collaborations and collaborate with one or more parties for any such collaboration content, a method comprising the steps of: initiating a collaboration by the user by preparing the content for a collaboration using the solution system; inviting one or more parties to collaborate with the user on the prepared content for the collaboration; collaborating on the prepared content for the collaboration by sending the prepared content for collaboration to the parties and making available to the user and the parties all collaboration activity; and completing the collaboration by agreement between the user and the parties, and preparation of the content agreed to in the collaboration and transmission the agreed content to the parties and the user.

The method as described above wherein the activities in the steps of collaborating and completing are open and communicated between the user and more than one party or closed and communicated between the user and one party.

The method as described above further including the step of notifying the user and the parties of any collaboration activity.

### BRIEF DESCRIPTION OF THE DRAWINGS

FIG. 1 is a functional diagram depicting the solution system connected to a user and one or more party devices.

FIG. 2 is a functional diagram depicting the components in the solution system.

FIG. 3 is a functional diagram depicting the components in the solution system.

FIG. 4 is a functional diagram of a user dashboard or control panel screen in the solution system.

FIG. 5 is a functional diagram of a party dashboard or control panel screen in the solution system.

FIG. 6 is a functional diagram of another user dashboard or control panel screen in the solution system.

FIG. 7 is a functional diagram of another user dashboard or control panel screen in the solution system.

FIG. 8 is a functional diagram of another user dashboard or control panel screen in the solution system.

FIG. 9 is a functional diagram of a dashboard or control panel screen used by a user and other parties to negotiate and complete collaborations.

### DETAILED DESCRIPTION

While various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

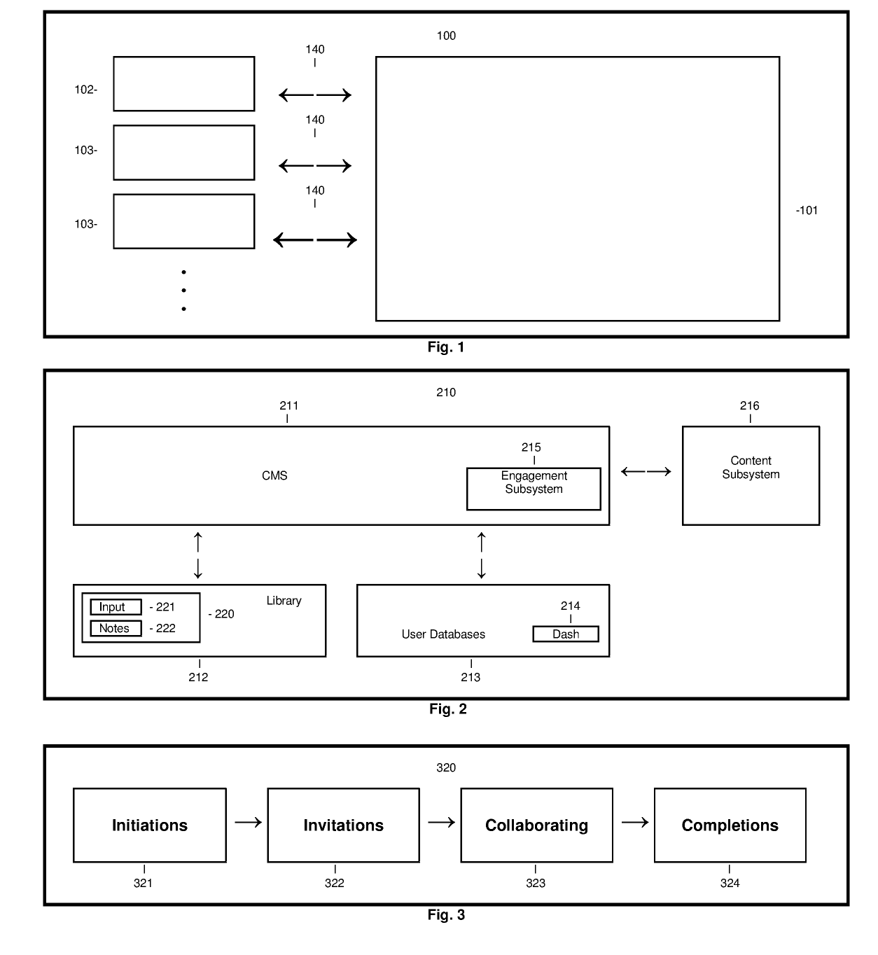

Referring now to FIG. 1, a functional diagram of a system 100 including the solution system 101 is depicted. The solution system 101 is shown connected by a communication medium 140, such as the internet or other network, to a user device or interface 102, and one or more third party devices or interfaces 103. A user engages the solution system 101 using the user device 102 and thereafter, if desired, communicates with third parties, via the solution system and the party devices 103.

The user device(s) 102 and the party device(s) 103 may be of a wide variety of types including, but not limited to, a terminal, PC, laptop, tablet or mobile phone, having a display. The solution system 101 may reside in a server or data center or other suitable hosting mechanism and may also be distributed among remote hosting mechanisms. It will be appreciated that the system 100 may be embodied in a variety of configurations including, but not limited to: cloud computing; dedicated system; or distributed system throughout an organization, campus or building. For example, some users/organizations may desire the solution system 101 to be deployed on their own servers while, simultaneously other users/organizations may prefer a cloud computing configuration.

In the system 100, a user, using a user device 102, engages the solution system 101 to create the terms or content for a collaboration, such as, for example, a contract, and thereafter, communicates with one or more parties, using party devices 103 via the solution system 101 to collaborate (e.g. discuss, negotiate, etc.) on the content of the collaboration until the collaboration is agreed on or otherwise completed or ended between the user and the parties.

Referring now to FIG. 2, a functional diagram of the components or functions of the solution system 210 is depicted. In FIG. 2, these functions are grouped together for convenience of explanation to reflect the various functions and processes of the solution system 210 the users and parties would be interacting with. It will be appreciated that the CMS 211 may be implemented in a variety of different configurations to achieve these functionalities.

The content management system (CMS) 211 controls the interactions with users and parties and to and from the library 212 and the user databases 213. The CMS 211 may contain a number of sub-components such as, for example, a project management system. The CMS 211 is also depicted with an engagement subsystem 215 which allows a user to register with and/or log into the solution system 210. It will be appreciated, however, that the engagement subsystem 215 may be configured and/or deployed anywhere within the solution system 210.

The library 212 contains numerous terms, clauses, forms, documents, contracts, term sheets and agreements for a plurality of situations including, but not limited to, employment, financing, partnership and license agreement, resolutions, minutes, standards, position statements available to a user for creation of the content for a collaboration. The user may also create his/her/its own content for any collaboration. In addition to the language or content in any collaboration document 220 in the library 212, any of such collaboration document 220 may be enabled with either or both of: a collaboration document inputting facility 221 to iteratively take the user through various terms/clauses/sections of the collaboration document for which the user must supply information or data; and a notes/tips facility 222 with notes, tips, explanations, relevance and examples of alternative language for various clauses in the collaboration document. It will be appreciated that a plurality of alternatives are possible for linking an inputting facility 221 and/or notes/tips facility 222 to a collaboration document 220 and that all such alternatives are within the scope of the present invention.

To ensure fairness between the user and the parties, on certain collaborations in the library 212 such as contracts, for example, the language or content of some clauses or terms may be designated as non-changeable by either the user or the parties. Additionally, the solution system 210 and the library 212 may be enabled to allow the collaboration documents to be displayed and discussed in a single alternative language or in different languages.

In the user databases 213, a database or record is created and kept for each user of all collaboration documents initiated or created; the phase or stage the collaboration is in; the collaborating (e.g. interactions and/or negotiations on each collaboration to and from the user with each party, including any changes agreed to); and completed and/or signed matters. A user control panel or dashboard 214 or other suitable mechanism is created for each user on which the user can see and track all collaboration documents initiated or created, the status or phase each collaboration, and a record of all interactions with parties and from which the user can initiate or create new collaborations, launch new phases or steps for any collaboration and/or otherwise manage activities in the solution system 210

The solution system 210 also includes a collaboration content subsystem 216. This subsystem 216 contains a taxonomy and/or guide to assist the user in creating the content for new collaborations. For example, through a series of pop-up menus and iterative questions, instructions, etc. from the solution system 210 to the user and replies thereto by the user, the subsystem 216 can guide the user to the appropriate collaboration document in the library 212. It will be appreciated, however, that this subsystem 216 may be configured and/or deployed anywhere within the solution system 210, including as part of the CMS 211.

While the functions of solution system 210 including the CMS 211, library 212, user database 213, the engagement subsystem 215 and the collaboration content subsystem 216 have been depicted in FIG. 2 as distinct components, it will be appreciated that the various sub-components of each may be constructed or configured in a variety of ways and deployed together or distributed. Thus, the solution system 210 is flexible and may be configured as needed for a particular application and/or user. Also, the user may use the solution system 210 privately or within his/her/its own organization or company or use it publicly to interact with unaffiliated parties.

Referring now to FIG. 3, a functional chart of the principle steps or phases 320 used in the solution system 210 to complete a collaboration is depicted. These phases include initiations 321, invitations 322, ncollaborating 323, and completions 324.

Prior to first using the solution system 210, a user will register with the solution system 210 using the engagement subsystem 215. Thereafter, the user can log into the solution system 210 as desired. When the user registers, the solution system 210 creates a dedicated database in the user databases 213 for this user.

All activities with regard to this user will be kept track of or stored in his/her/its dedicated database which is available to the user and summarized through/on this dashboard. If the user wishes to maintain separate databases for different collaborations, for example, he/she/it would register with the solution system 210 using a different user name, for example. It will also be appreciated that a plurality of different ways or methods for record keeping are within the scope of the present invention.

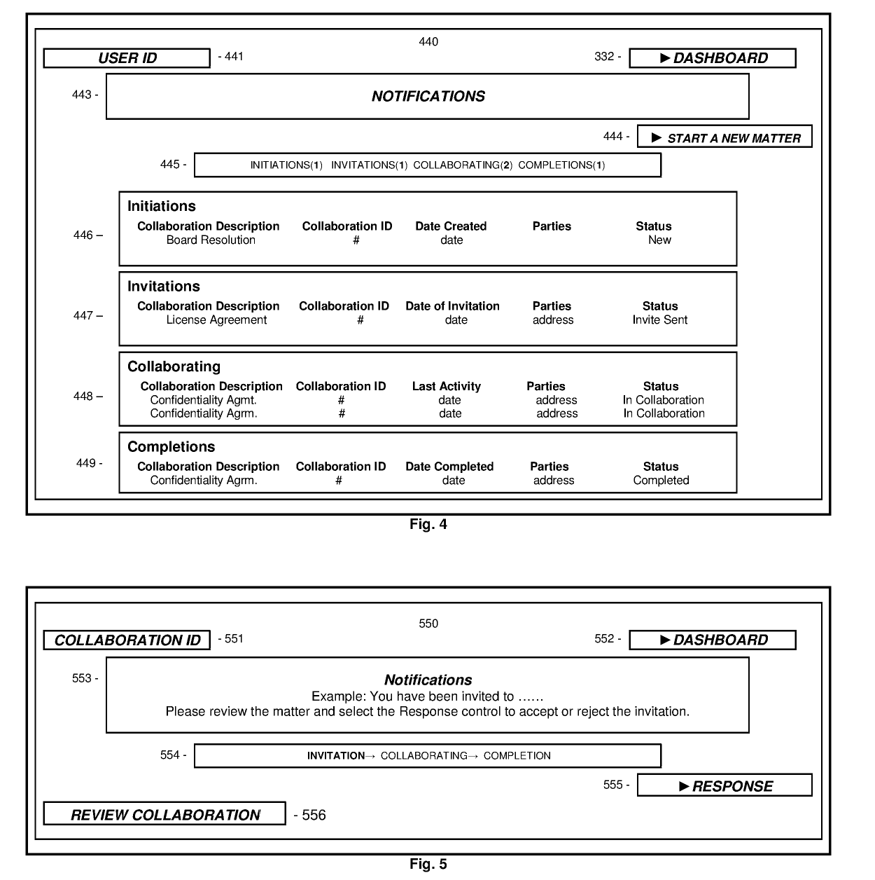

Referring now to FIG. 4, the equivalent of a home dashboard page or screen 440 for a particular user's dedicated control panel or dashboard is depicted. The dashboard screen 440 may display; a user identification or ID 441; and a data base control 442. The user ID 441 may include a photo, logo, name, address, email address, etc. The data base control 442 allows the user to navigate through the various pages or screens of his/her/its dashboard.

Dashboard screen 440 may also display a notifications window 443 to alert the user of any party activity that has occurred since his/her/its last log in such as, for example, a party acceptance of an invitation, a counter-offer or agreement/acceptance of/to a collaboration. On other user dashboard screens or pages, the notifications window may be used for other purposes. For example, if the user is creating or ‘initiating’ a new collaboration and has reached the appropriate form or collaboration document using the solutions system 210, the notifications window may be used for a message to indicate the type of collaboration document selected such as, for example, a confidentiality agreement. The notifications window 443 and the notification/message windows for other dashboard screens or pages may be enabled with a control that allows the operator to hide it.

Dashboard screen 440 may also display a ‘Start a New Matter’ control 444 allows the user to start a new collaboration and use the collaboration content subsystem 216 to locate the correct form or collaboration document; and a Summaries Line 445 which provides the user with the totals of collaborations in each phase or step of the process 320.

The remainder of the user's home page dashboard screen 440 provides the user with more detail on each of the user's collaborations for each stage or step in the process 320 and links or connections to other areas of the user's database. This remainder of dashboard screen 440 includes an initiations detail 446, an invitations detail 447, a collaborating detail 448 and a completions detail 449. The initiations detail 446 lists all of the new collaborations or initiations (created by the user) by Collaboration Description, Collaboration ID, Date Created, Party and Status. The invitations detail 447 lists the user's collaborations (for which invitations have been sent to parties but not responded to) by Collaboration Description, Collaboration ID, Date of Invitation, Party, and Status. The collaborating detail 448 lists all of the user's collaborations (which are in negotiations, discussions or collaboration) by Collaboration Description, Collaboration ID, Date of Last Activity, Party and Status. The completions detail 449 lists all of the user's collaborations (which have been completed or agreed to) by Collaboration Description, Collaboration ID, Date Completed, Party and Status.

Still referring to FIG. 4, the solution system 210 may be configured to assign a specific collaboration ID (identification) for any new document or collaboration created by the user, such as collaboration ID 551 in FIG. 5. This collaboration ID may include data that identifies the user, type of document or collaboration and a specific identification number. The solution system 210 is enabled to allow the user to have, for any collaboration, either an open process 320 (i.e. the user and more than one party), or a closed process 320 (i.e. the user and one party). The collaboration ID is one alternative for achieving both open and closed processes 320. The solution system 210 is enabled to keep records, matters, and generate communications by collaboration ID. All activities and records for a collaboration after the initiations phase 321 are made available, accessible and communicated to the user and all parties designated by the user with/for the collaboration ID for any collaboration, thus achieving an open process. If the user wants a closed process 320 for the same content in a particular collaboration document with more than one party, the user can easily use the ‘Start a New Matter’ control 444 to create a new collaboration document (having the same content and a different collaboration ID) for each additional party. The solution system 210 will generate separate collaboration IDs for each such additional ‘New Collaboration’, thus achieving for the user a closed process with multiple parties for the same (initial) collaboration content. It will be appreciated however, that there are alternatives for achieving the open and closed process 320 functionality. One such alternative would entail the solution system 210 enabling the user, when entering the invitations phase 322 and designating the parties for (invitations to) a new collaboration, to elect between open and closed process 320. The solution system would then generate different matter IDs for all parties designated by the user for a closed process 320.

For example, as depicted in FIG. 4, the user created a Confidentiality Agreement collaboration document (e.g. as a pre-requirement to a License Agreement collaboration document that the user wishes to collaborate, negotiate, etc. with one or more of three different parties). For this Confidentiality Agreement collaboration document, the user easily created two additional (new) documents or matters, using ‘Start a New Matter’ control 444, resulting in three collaboration documents, with different collaboration IDs, having the same content. For each one of the three collaboration IDs, the user selected a different one of the three parties for invitation and thus launched 3 closed process 320 collaborations (for the same (initial) collaboration document content. One of the parties has signed/agreed (as noted in the completions detail 449) and the other two parties are negotiating (as depicted in the collaborating detail 448). With regard to the License Agreement depicted in FIG. 4, again the user intends to have a closed process 320. The user had the solutions system 210 send an invitation to the party (that has completed and signed the Confidentiality Agreement) and is waiting for a response as noted in the invitations detail 447. In FIG. 4, all of the entries, for the Confidentiality Agreement and the license agreement, in invitations detail 447, the collaborating detail 448, and the completed detail 449, has different collaboration IDs.

Also in the example shown in FIG. 4, the user has created or is working on a new collaboration or initiation (e.g. a board resolution) for which he/she/it plans to have an open process 320. When the user is finished and ready to send out invitations, he/she/it can provide the solution system 210 with an (email) address for each and every party and have the system 210 send the invitation(s) to each such party and create an open process 320 going forward for the collaboration (e.g. board resolution). At that time, the solutions system 210 will move the collaboration from the initiations detail 446 to the invitations detail 447 and create an entry in the invitations detail 447 for each party to whom an invitation was sent, with the same collaboration ID.

The user dashboard 440 may have other functions and controls (e.g. a waste basket) which are not depicted in FIG. 4. It will be appreciated that the embodiment, arrangement and display of the user control panel or dashboard screen 440 as depicted in FIG. 4 is one many alternative embodiments that can be used within the scope of the present invention.

Referring back to FIG. 3, the initiation phase or step 321 of the process 320 pertains to the initiation or creation of any new collaboration including the preparation of the content for the collaboration document (e.g. contract, agreement, resolution, term sheet, etc.). The user can initiate a new collaboration on his/her/its dashboard screen 440 using the ‘start a new matter’ control 444. The solution system 210 activates the collaboration content subsystem 216 to assist and/or guide the user to the appropriate form or document in the library 212. The user may also elect to supply his/her/its own content for a collaboration.

When the user initiates any new matter, the solution system 210 updates the initiations detail 446 of the user's dashboard 440 as explained above. The full text of the collaboration document is in the user's database and available to the user.

Still referring to FIG. 3, when the initiations 321 phase for a matter or document is completed, the user may elect to send “invitations” or notices using the solution system 210 to parties with whom he/she/it wishes to collaborate (e.g. discuss, negotiate, etc.). The user may designate one or more parties, by email address, for example for this purpose. The solution system 210 creates a party dashboard, as described below, for each such designated party and sends each designated party an invitation (e.g. by email with an attachment, link or other connection method) to that party's dashboard (e.g. party dashboard screen 550). The solution system 210 will also: move the collaboration from the initiations phase 321 to the invitations phase 322 in the user's database and on the user's dashboard screen 440; and will keep records of all documents, changes, activities, etc. for the collaboration in the user's database by collaboration ID (e.g. collaboration ID 521 in FIG. 5).. It should also be appreciated that the user may elect not to enter the invitations phase 322 or other subsequent phases for a collaboration if, for example, he/she/it only wants to use the solution system 210 to create and prepare the content for his/her/its personal or private use.

Referring now to FIG. 5, a party invitation dashboard page or screen 550 is depicted. This dashboard screen 550 will be made accessible to each party designated by the user to receive an invitation. The dashboard screen 550 displays a Collaboration ID 551 (created by the solution system 210 as described above); a data base control 542 which allows the invited party to go to other dashboard pages or screens once the party has accepted the invitation; and a notifications window 553 which may be included to describe the notification (e.g. the invitation) and/or certain instructions.

The dashboard screen 550 may also display a status bar 554 which indicates the status of the collaboration in the process 320 by bolding, highlighting, different colors, etc. In this embodiment, the appropriate status is bolded. In FIG. 5, since the party is receiving the invitation, the ‘Invitations” status is designated. Should the party accept the invitation, the solution system 210 changes the status by designating the ‘Collaborating’ status.

The dashboard screen 550 also displays a ‘response’ control 555 which allows the party to select and send a response to the user and a ‘review collaboration’ tab 556 which, when selected by the party, will display or link the party to a screen or page where he/she/it can review the content of the collaboration document. The party dashboard screen 550 may also have other functions and controls (e.g. a waste basket) which are not depicted in FIG. 5.

When the party responds to the invitation using the ‘response’ control 555, the solution system 210 sends a notification, informing the user and all parties designated for the same collaboration ID 551, of the response (i.e. acceptance or rejection). For a rejection of an invitation by a party, the solution system 210 may be configured to deny or limit this parties' further access to the solution system 210 for this collaboration or collaboration document. If the party accepts the invitation, the solution system 210 will update the status of this matter, for both the party and the user, from ‘invitation’ to ‘collaborating’ and may remove dashboard screen 550 from such party's database and replace it with other dashboard screens with which the party may use to collaborate, etc. the collaboration document as will be described hereinafter. For a collaboration in an open process 320, the solutions system 210 can be enabled by the user, such that, the process 320 does not become open for any party for some of the phases (e.g. the collaborating phase 323 and the completions phase 324), until that party has accepted the invitation.

It will be appreciated that the embodiment of the party control panel or dashboard 550 as depicted in FIG. 5 is but one of many embodiments or alternatives that could be used within the scope of the present invention.

Referring back to FIG. 3, if a party receiving a user's invitation desires to participate, he/she/it accepts the invitation and the collaborating phase 323 of the process 320 for this matter (ID) commences. The solution system 210: notifies the user (and all parties with the same matter ID 550) of this accepted invitation; moves the collaboration, for this party or invitee on the users' dashboard screen 440 and for that party's dashboard, from the invitations phase 322 of the process 320 to the collaborating phase 323; and updates the user's database.

After reviewing the content of the matter, a party may wish to negotiate (e.g. or send a counter-offer for any one or more of the terms of the collaboration document). If so, using the appropriate party dashboard screen or page as described below, he/she/it creates the counter-offer and sends it via the solution system 210. The user (and all parties that are in the ‘collaborating’ phase 323 for this collaboration ID 550) are notified of the counter-offer, such as a notice in the notifications window 443 of the user dashboard 440 and provided with an updated dashboard screen to review and respond the counter-offer. The solutions system 210 also provides an adequate and easy method for the user and all parties receiving the counter-offer to see all of the changes made to collaboration document in the counter-offer. The solution system 210 also: records the counter-offer and all related details in the user's database and updates the user's dashboard screen 440 with an entry to the ‘collaborating’ detail 448. The user (or any party in the negotiation phase 323 of the process 320) may prepare and send responding counter offers and the solutions system 210 will record and notify in the same manner.

Still referring to FIG. 3, if, at any point in the negotiations phase 323, either the user or any party is ready to agree to the collaboration document or counter-offer they can elect to do so. When the user and all of the other parties, if any, for a matter (with the same collaboration ID) have agreed, the solution system: generates the appropriate notifications; changes the status on all appropriate dashboard screens, such as user dashboard screen 440, to ‘completed’: and generates a document with all of the content including any changes made in the collaborating phase 323 for both the user and the party or parties. This document can be signed by the user and the parties as appropriate. The solution system 210 can also be configured by the user and the parties to generate signatures for the completed document for the matter (i.e. having the same collaboration ID) in an appropriate document format (e.g. pdf).

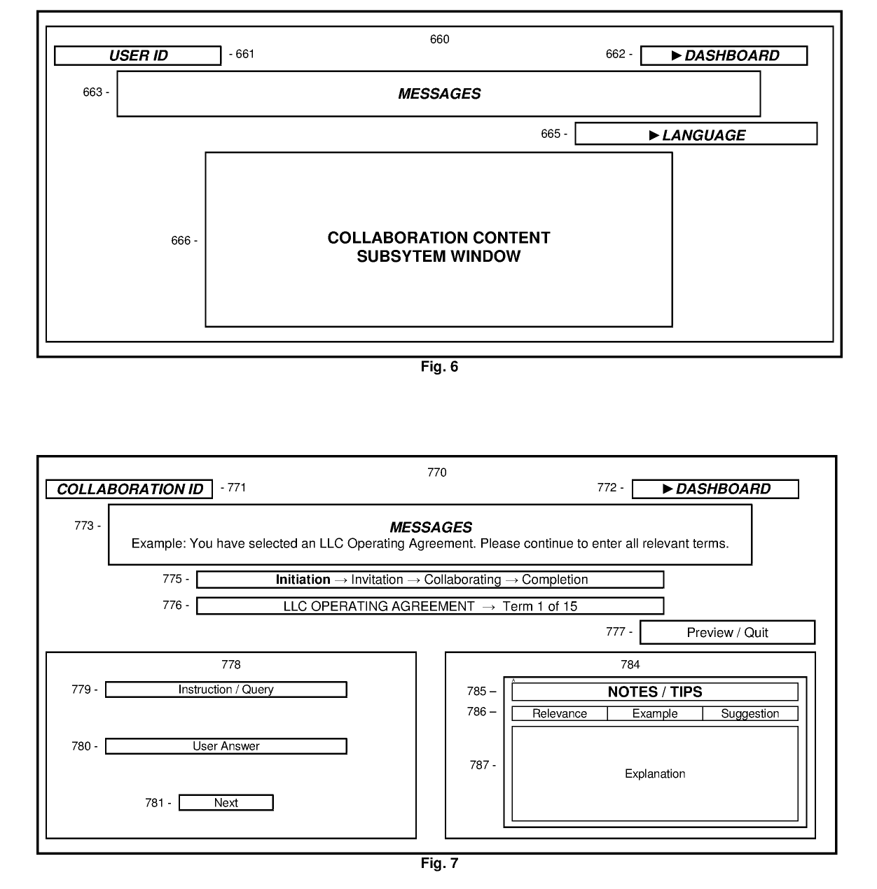

Referring now to FIG. 6, an example is depicted of the user creating a new collaboration in the solution system 210 using the user control panel or dashboard 660. For the example in FIG. 6, the user has already selected the ‘Start a New Matter’ control 444 on user dashboard screen 440. The solutions system 210 has brought up for display to the user, a user dashboard screen 660 and engaged the collaboration content subsystem 216 resulting in a pop-up window 666 or other suitable device to appear on the user dashboard screen 660 for user interaction with the collaboration content subsystem 216. By responding to the questions or items that iteratively appear in the pop-up window 665, the solution system 210 directs the user to the appropriate form, document, etc. in the library 212 and the user makes his/her/its selection, such as, for example, an LLC Operating Agreement. A notification window 663 is also depicted which, while the user is using the collaboration content subsystem 216, may be used to convey messages and information to the user.

On the user dashboard screen 660, the solution system 210 has been configured to display a user ID 661 and “Dashboard’ control 662 for navigation of the user dashboard. The solution system 210 may also be enabled with a multiple language facility. For example, by engaging the language window 665, the user may select any one of the languages offered and complete the preparation of the content for the new collaboration in the language selected. Moreover for certain types of collaborations, the solution system 210 can be enabled to permit the collaborating to occur in multiple languages.

Although the description of solutions system 210 herein is mainly focused on contracts and agreements, it will be understood that the solutions systems can be used for a plurality of other applications, including to develop and/or distribute resolutions, position statements, messages, policies, procedures, standards, training modules, manuals, strategies, tactics, commentary, advertising copy, translations etc. The solutions system 210 can be used by any user that wishes: to get comments, acceptance, suggestions, agreements, signatures, etc. to a collaboration document; in either an open or closed process; and/or a documented record of activity. Additionally, the collaboration content subsystem 216 can be enabled to allow a user to create his/her/its own collaboration document, whether or not a suitable form or document is available in the library 212.

Referring now to FIG. 7, another dashboard screen is displayed for the user to use to in the process 321 of creating or initiating a new collaboration. In FIG. 7, the user control panel or dashboard screen 770 displays a screen that the user would see after having selected the collaboration document (e.g. LLC Operating Agreement) using the collaboration content subsystem 216 as described above. This dashboard screen 700 displays: the collaboration ID 771; a dashboard control 772 to enable the user to navigate his/her/its dashboard; a notifications or messages window 773 with an appropriate message (e.g. “You have selected an LLC Operating Agreement. Please continue to enter all relevant terms.”); and a (collaboration) status window 775 with the appropriate status (e.g. Initiation) indicated (e.g. by bolding). When the user selected an appropriate form or document for the collaboration (e.g. LLC Operating Agreement) using the process described above for FIG. 6, the solution system 210 generated a collaboration ID 771 for the matter.

This dashboard screen 770 also displays: a collaboration description and section window 776 which indicates the matter or document type (e.g. ‘LLC Operating Agreement’) and the term/clause/section (e.g. ‘Term 1 of 15’) of the collaboration document appearing in a workspace window 778; and a document options window 777 which provides the user with options such as, for example, a ‘preview’ option displaying the text of a term, clause or section or the entire collaboration document or document and a ‘quit’ option to allow the user to save the changes, etc. and return at a later time.

The solution system 210 is configured to access and display the document inputting facility 221 for a document 220 selected (by the user) for a collaboration as described, by means of the workspace window 778 on the dashboard screen 770. The workspace window 778 is used to enable the user to fill in any text, etc. required for a term, clause or section of the new collaboration (e.g. ‘LLC Operating Agreement’). The workspace window 778 also includes an ‘Instruction/Query’ window 779 which provides iterative instructions or questions to the user. For example, the very first instruction or query to the user may be to fill in the appropriate name. The user answers or fills in the ‘user answer’ window 780 (e.g. his/her/its name for the first instruction/query) for each instruction or question appearing in the ‘Instruction/Query’ window 779 for the term, clause or section and then clicks on the ‘next’ window 781 to go to the next instruction or query for the term, clause or section. This process is continued until the term, clause or section of the new collaboration document is completed (e.g. ‘LLC Operating Agreement’, term 1), at which point the solutions system 210 moves to the next term, clause or section and starts the same process for the next term, clause or section (e.g. ‘LLC Operating Agreement’, term 2). When the solutions system 210 moves to a new term, clause or section, the matter description/section window 776 is updated (e.g. ‘Term 2 of 15’). In a similar fashion, this process is repeated until all of the instructions or queries in the collaboration document (e.g. ‘LLC Operating Agreement’) have been responded to by the user.

The solution system 210 is also configured to access and display to the user, the notes/tips facility 222 for a document 220 selected (by the user) for a collaboration, by means of a ‘note/tips’ window 784 depicted on dashboard screen 770. The ‘note/tips’ window 784 acts as an aid to the user for answering or filling in a user answer window 780 for instructions or queries in the ‘Instruction/Query’ window 779. In this embodiment of the present invention, the ‘note/tips’ window 784 has title box 785 (e.g. ‘Notes/Tips’), an option window 786 and a viewing window 787 where the note or tip is displayed. The option window 786 allows the user to select and have displayed in the viewing window 787, notes and tips such as: the relevance or importance of the instruction or query in the ‘Instruction/Query’ window 779; example(s) of appropriate considerations, etc. for the instruction or query in the ‘Instruction/Query’ window 779; and suggestions for answering the instruction or query in the ‘Instruction/Query’ window 779. The solutions system 210 may provide such notes and tips for some or every one of the instructions or queries appearing in the ‘Instruction/Query’ window 779. It will be appreciated that a variety of different approaches and configurations may be used to achieve the functionality of the ‘note/tips’ window 784 and/or the workspace window 778 and are within the scope of the present invention.

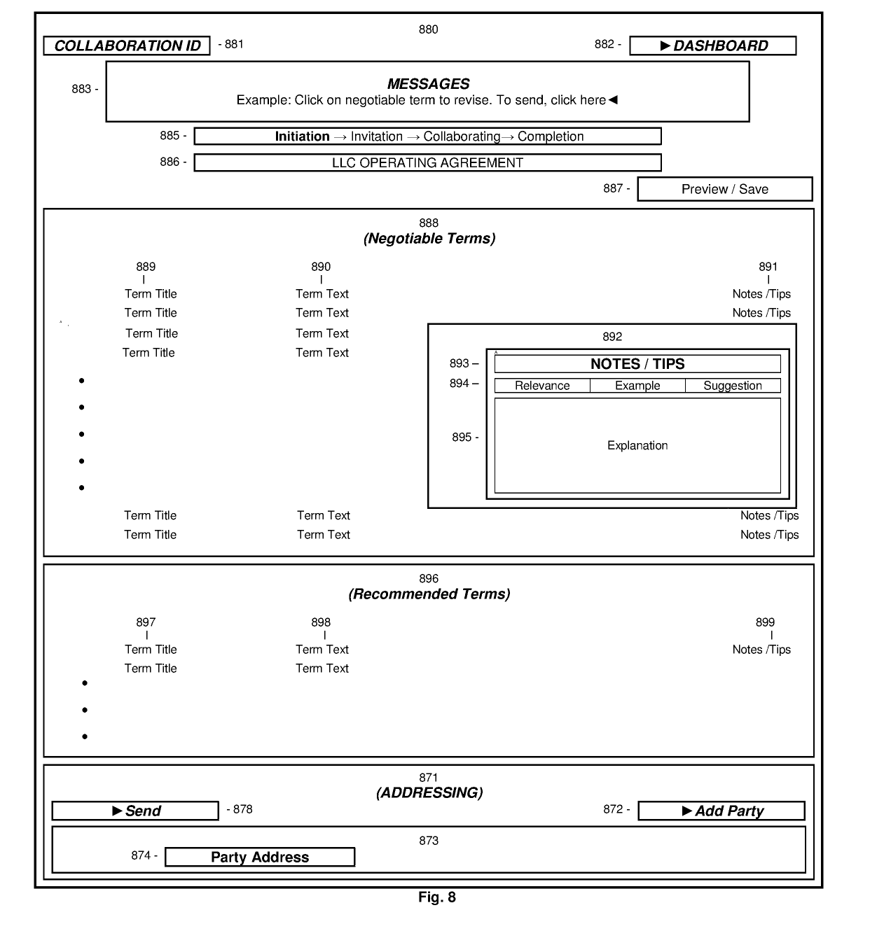

Referring now to FIG. 8, the user has completed responding to the instructions or queries appearing in the ‘Instruction/Query’ window 779 for the new matter (e.g. ‘LLC Operating Agreement’), and the solution system 210 is now previewing the text for these inputs on the dashboard 880 screen. On this dashboard screen 880, the collaboration ID 881 and the ‘Dashboard’ control 882 are present and function as described previously. The notifications or messages window 883 may/will display a message(s) with instructions on how to proceed with the review of the collaboration document (e.g. ‘Click on negotiable term to revise. To send, click here’). The status window 885 indicates (e.g. by bolding) that the collaboration is in the ‘initiations’ phase and the collaboration title window 886 indicates the type of collaboration (e.g. ‘LLC Operating Agreement’). The document options window 887 provides the user with options, such as for example, to: ‘preview’ an entire term, clause or section of the new collaboration document; the entire collaboration document; or ‘save’ any changes.

The ‘negotiable terms’ review window 888 displays the changeable or ‘negotiable’ terms, clauses or sections of the new collaboration document (e.g. ‘LLC Operating Agreement’). The ‘negotiable terms’ review window 888 is arranged by: a term title or descriptor field 889, a term text (including the user's responses to the instructions or queries appearing in the ‘Instruction/Query’ window 779) field 890; and a notes/tips option field 891. In the embodiment of the present invention as depicted in FIG. 8, the term text field 890 for any (‘negotiable’) term, clause or section may be changed or edited by clicking on the term text field 890 for the term, clause or section. This field 890 for each term or clause may also be arranged such that, for example, all or only a portion of the text for a term, clause or section is displayed and is changeable/‘negotiable’. The entire text of a term, clause or section, including non-changeable or non-‘negotiable’ portions, may be viewed at any time by selecting the preview function in the document options window 887.

If the user selects or clicks on the notes/tips option field 891 for any term, clause or section of the new collaboration document, a notes/tips window 892 pops up or is otherwise displayed. The ‘note/tips’ window 892 accesses the notes/tips facility 222 for a document 220 for collaboration and may include an optional title box 893 (e.g. ‘Notes/Tips’), an option window 894 and a viewing window 895 (where the note or tip is displayed). The option window 894 allows the user to select and have displayed in the viewing window 895, for example: the relevance or importance of the term; example(s) of alternatives, etc.; and suggestions for deciding/proceeding. In FIG. 8, for example, the user has clicked on the notes/tip option 891 for the third term in the negotiable’ review window 888 and the notes and tips for that third term are displayed ‘note/tips’ window 892

Still referring to FIG. 8, dashboard 880 screen also displays a non-changeable or ‘recommended terms’ or clauses window 896. In this window 896, the non-changeable or ‘recommended terms’, clauses or sections of the new collaboration document (e.g. ‘LLC Operating Agreement’) are arranged by term title or descriptor field 897 and a non-changeable term text field 898. Each ‘recommenced’ term may or may not have, as desired, a notes option field 899 where the user or operator may elect to enable a pop-up ‘note/tips’ window similar to pop-up ‘note/tips’ window 892. The terms, clauses or sections appearing in the non-changeable or ‘recommended terms’ or clauses window 896 are not editable or changeable by the user.

During the user's review, he/she/it may at any time document click on options window 887 to preview the term and any changes made or save any changes made. The user or operator may also preview review the document or matter in its entirety at any time. When the user is finished, he/she/it can save all changes and return to it at another time or elect to send an invitation (to collaborate) to one or more parties to discuss, negotiate, etc. the collaboration document (e.g. ‘LLC Operating Agreement’).

When the user is ready to send invitations to parties, he/she/it can do so by, for example, clicking on the ‘send’ option in notifications/messages window 883. The solution system 210, in response to this action, may provide the user with a pop-up ‘addressing’ window 871, for example, for the user to use for this purpose. The ‘addressing’ pop-up window 871 may include a window 873 with a fill-in ‘Party Address’ field 874. An ‘add party’ control 872 may also be included in the ‘addressing’ pop-up window 871. Each time the user wishes to add a party to receive an invitation for document or matter (e.g. ‘LLC Operating Agreement’), he/she/it may click or select the ‘add party’ control 872 and the solution system 210 with add an additional, fill-in ‘Party Address’ field 874 entry to ‘addressing window’ 873.

For each (party) entry in the fill-in window 873, the user inserts the (email) address for a party in the Party Address field 874. As described above, if there is more than one party (address) in window 873, an open process 320 will occur. If the user wants a closed process 320 with more than one party for the same content of a document or matter, the user will create additional new collaborations (for the same initial) content and with different collaboration IDs, for each party.

After completing the address or addresses for the party or parties, the user may select or click on a ‘send’ control 878. In response, the solution system 210 will create an appropriate party dashboard, including party dashboard screen 550, for each invitee or party selected by the user and send the invitation(s) to such parties. The solution system 210 will also: change the status on all relevant dashboard screens from initiation(s) to invitation(s); and update the user's home page screen dashboard 440 (e.g. see FIG. 4) appropriately, including moving the matter from the initiations detail 447 to the invitations detail 448 with an entry for each party to whom the invitation was sent including the Party (email) address. The user can also elect to send out invitations to additional parties at a later time.

Still referring to FIG. 8, the ‘negotiable terms’ window 880 lists the negotiable or changeable terms/clauses/sections for the collaboration document (e.g. ‘LLC Operating Agreement’) and the ‘recommended terms’ window 896 lists the non-negotiable or non-changeable terms/clauses/sections for the collaboration document such as, for example an arbitration clause. Additionally, the solutions system 210 can be configured to have portions of the text for any one or more of the terms/clauses/sections in the negotiable or changeable terms/clauses/sections grouping (i.e. in the ‘negotiable terms’ window 888) arranged as non-changeable or non-negotiable and such portions will not be changeable or editable by the user.

The arrangement of all or portions of any term as non-negotiable or non-changeable is done in the interest of fairness to the user and/or the parties since any of them may be unsophisticated with regard to the subject matter or content of the collaboration. This also enables the user and the parties to discuss, negotiate and/or agree economically, without the need for attorneys and/or other professionals. The non-negotiable or non-changeable portions of terms/clauses/sections are those for which the solution system 210 has provided mutually fair text or language based on common practices, for example. Additionally, the solution system 210 limits the negotiations and counteroffers to the negotiable or changeable portions of terms/clauses/sections. It will be understood that the solution system 210 can be arranged differently and/or special features added to allow changes to non-negotiable terms when appropriate.

Additionally, and also in the spirit of fairness to all, after the invitations are sent to the invited parties, the user and all the invited parties will be working with identical dashboard screens for the collaborating negotiations and completion phases, 323 and 324, respectively, of the process 320 and whether or not the process is open or closed.

It will be appreciated that a plurality of different alternatives for arranging, setting up and/or displaying the functionality of dashboard screen 880 are possible and are within the scope of the present invention.

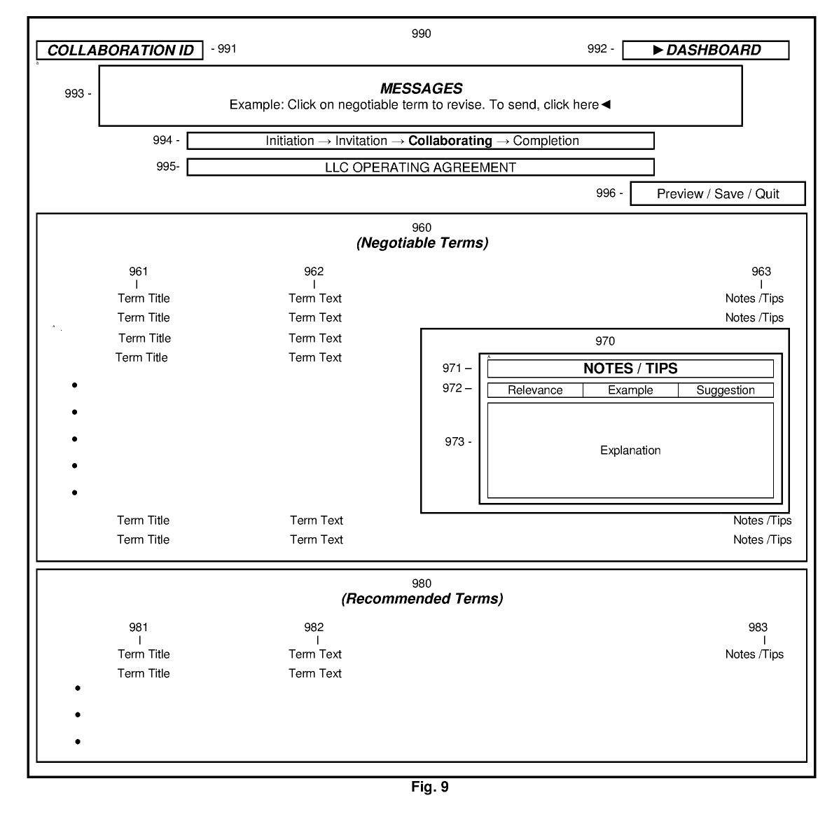

Referring now to FIG. 9, a dashboard screen 990 is depicted for the user and all of the invited parties to use in the collaborating phase 323 and the completions phases, 324 of the process 320 for the collaboration (e.g. ‘LLC Operating Agreement’). On this dashboard screen 990 the collaboration ID 991 and the ‘Dashboard’ control 992 are depicted and function as described previously. The notifications or messages window 993 may/will display a message with instructions on how to proceed with the review of the matter or document (e.g. Click on the negotiable term to revise. To send, click here’). The status window 994 indicates (e.g. by bolding) that the collaboration is in the ‘collaborating’ phase and the collaboration title window 995 indicates the type of matter or document (e.g. ‘LLC Operating Agreement’). The document options window or control 996 provides the user with options, such as for example, to: ‘preview’ an entire term, clause or section of the collaboration document; the entire collaboration document; ‘save’ any changes; and to ‘quit’ a session to return later

The ‘negotiable terms’ window 960 displays the changeable or ‘negotiable’ portions of terms/clauses/sections in the collaboration document (e.g. ‘LLC Operating Agreement’). The window 960 is arranged by: a term title or descriptor field 961, a term text field 962; and a notes/tips option field 963. The text for the changeable/negotiable portion of (‘negotiable’) term/clause/section may be changed or edited by clicking on the term text field 963 for that term/clause/section. The entire text of a term or clause, including any non-changeable or non-‘negotiable’ portions, may be viewed at any time by selecting the preview function in the document options window 996.

If the user selects or clicks on the notes/tips option field 963 for any term, clause or section of the new document or matter, a notes/tips window 970 pops up or is otherwise displayed. The ‘note/tips’ window 970 may include an optional title box 971 (e.g. ‘Notes/Tips’), an option window 972 and a viewing window 973 (where the note or tip is displayed). The option window or control 972 allows the user to select and have displayed in the viewing window 973, for example: the relevance or importance of the term; example(s) of alternatives, etc.; and suggestions for deciding/proceeding. In FIG. 9, for example, the user has clicked on the notes/tip option 963 for the third term in the ‘negotiable’ terms' review window 960 and the notes and tips for that third term are displayed ‘note/tips’ window 973.

Still referring to FIG. 9, the dashboard screen 990 also displays a non-changeable or ‘recommended terms’ sections or clauses window 980. In this window 980, the non-changeable or ‘recommended terms’, clauses or sections of the collaboration document (e.g. ‘LLC Operating Agreement’) are arranged by term title or descriptor field 981 and a non-changeable term text field 982. Each ‘recommenced’ term may or may not have, as desired, a notes option field 993 where the user or operator may elect to enable a pop-up ‘note/tips’ window similar to pop-up ‘note/tips’ window 970. The terms, clauses or sections appearing in the non-changeable or ‘recommended terms’ or clauses window 980 are not editable or changeable by the user or the parties.

The notes/tips and the designations of negotiable vs. non-negotiable depicted in FIG. 9 are identically available to the user and all of the parties in the collaborating phase 323 and are identical to the notes/tips and the negotiable vs. non-negotiable designations as described for FIG. 8 for the user in the initiations phase 321.

If a party or the user wishes to make an offer or counter-offer, he/she/it can click on the term text field 962 of a negotiable term in the ‘negotiable terms’ window 960 for a term he/she/it wants to change or edit. After making the changes/edits to that term, the save function in the document options control 996 can be clicked on to save the changes/edits. This process is repeated for each and every term/clause/section in the ‘negotiable terms’ window 960 that he/she/it wants to change.

At any time, the user or party may, by using the preview option in the options control 996, preview any term/clause/section or the entire collaboration document and any changes made. When the user is finished, he/she/it can save all changes and return to it at another time or elect to send the offer or counter-offer to the collaboration (e.g. ‘LLC Operating Agreement’) to the user and all other designated parties by clicking on the send control in the message window 993. The solution system 210 will send the offer or counter-offer, with all changes clearly denoted, to the user and all other designated parties for the matter along with an appropriate notification of the offer or counter-offer. The solutions system also will also record the offer or counter-offer and all related data thereto in the user's database for this collaboration (ID).

If the user or a party wishes to agree/complete the current offer or a counter-offer for a collaboration (e.g. ‘LLC Operating Agreement’), he/she/it can select the Completion option in the status window 994. The solution system 210 will send a notification of the agreement/acceptance to the user and other enabled parties and record the event in the user's database for this collaboration (ID). When the user and all enabled parties have agreed/accepted, the solutions system will; update the user database, change the status for the collaboration (e.g. ‘LLC Operating Agreement’), to ‘Complete’ on all user's and enabled parties' dashboards; and send a final copy of the completed collaboration document to user and such parties. As mentioned above, the solution system 210 can also be enabled to send a completed and signed version of the collaboration document in an appropriate format, such as pdf, at this time.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. An automated solution system for enabling a user to prepare content for one or more collaborations and collaborate with one or more parties on the content for any such collaboration, the solution system comprising:
an enabling system to allow use of the solution system;
one or more libraries with information and documents for preparing content for a collaboration;
one or more databases for tracking and recordkeeping for one or more collaborations; and
a content management system for controlling interactions between the enabling system, libraries and user databases.

2. The solution system of claim 1 further comprising:
a control panel for display of the content and status of collaborations and for use of the solution system.

3. The solution system of claim 1 wherein the user may initiate and prepare content for one or more collaborations.

4. The solution system of claim 1 wherein the user may designate one or more parties for a collaboration and invite such parties to collaborate.

5. The solution system of claim 1 wherein collaborating among the user and the parties for a collaboration may be enabled and collaboration activity made known to the user and the parties.

6. The solution system of claim 5 wherein changes to the content of a collaboration are tracked and differentiated.

7. The solution system of claim 1 wherein collaborations that are completed or agreed upon are so designated.

8. The solution system of claim 7 wherein a final version of the content for a collaboration is generated upon completion.

9. The solution system of claim 8 wherein authorized signatures may be generated for a completed collaboration.

10. The solution system of claim 1 wherein the user and the parties to a collaboration are sent notifications of collaboration activity.

11. The solution system of claim 1 wherein explanatory information for the content of a collaboration are displayed to the user and the parties.

12. The solution system of claim 1 wherein portions of the content for a collaboration may be made non-changeable.

13. The solution system of claim 3 further comprising:
a collaboration content subsystem wherein, from responses by the user to one or more instructions or questions from the collaboration content subsystem, the solution system identifies an appropriate document for the user to use for preparing content for a collaboration.

14. The solution system of claim 1 wherein different languages may be used.

15. An automated system for assisting a user to prepare content for a matter, the system comprising:
one or more libraries with documents that can be selected for use by a user;
an enabling system to allow the user to access such documents;
and wherein, one or more of the documents have notes with explanatory information to assist the user with preparing the content of the matter.

16. The system of claim 15 wherein the notes are displayable to one or more parties in collaboration with the user.

17. The system of claim 15 further comprising:
a content subsystem wherein, from responses by the user to one or more instructions or questions from the content subsystem, the system identifies an appropriate document for the user to use for preparing the content of a matter.

18. In an automated solution system for enabling a user to prepare content for one or more collaborations and collaborate with one or more parties for any such collaboration content, a method comprising the steps of:
initiating a collaboration by the user by preparing the content for a collaboration using the solution system;
inviting one or more parties to collaborate with the user on the prepared content for the collaboration;
collaborating on the prepared content for the collaboration by sending the prepared content for collaboration to the parties and making available to the user and the parties all collaboration activity; and
completing the collaboration by agreement between the user and the parties, and preparation of the content agreed to in the collaboration and transmission the agreed content to the parties and the user.

19. The method of claim 18 wherein the activities in the steps of collaborating and completing are open and communicated between the user and more than one party or closed and communicated between the user and one party.

20. The method of claim 18 further including the step of:
notifying the user and the parties of any collaboration activity.
